(19) United States
(12) Patent Application Publication
(10) Pub. No.: US 2006/0031337 A1
(43) Pub. Date: Feb. 9, 2006

(54) Methods and systems for broadcasting offers over electronic networks

(76) Inventor: Mike Insang Kim, Rancho Santa Margarita, CA (US)

Correspondence Address: STETINA BRUNDA GARRED & BRUCKER, 75 ENTERPRISE, SUITE 250, ALISO VIEJO, CA, 92656, US

(21) Appl. No.: 10/913,617

(22) Filed: Aug. 6, 2004

(51) Int. Cl. G06F 15/16

(52) U.S. Cl. 709/206

(57) ABSTRACT

An electronic message broadcasting system is provided for facilitating an online transaction between a sending party and a group of users. The system provides functionality for receiving an electronic message comprising an offer to buy or sell from the sending party and broadcasting the message to the users. The system can selectively broadcast the message to a first and/or second computing device associated with each user, depending on message forwarding preferences of each user and an online status of the first computing device associated with each user. The system can further provide functionality for selectively converting the message from an email format to a text message format in order to broadcast the message to mobile computing devices capable of receiving messages in text message format.

### CROSS-REFERENCE TO RELATED APPLICATIONS

Not applicable

### STATEMENT RE: FEDERALLY SPONSORED RESEARCH/DEVELOPMENT

Not Applicable

### FIELD OF THE INVENTION

The present invention relates generally to technology for facilitating online transactions, and more particularly to methods and systems for broadcasting electronic offers over different communication media.

### BACKGROUND OF THE INVENTION

With the rise of the Internet and network connectivity, it has become increasingly important for persons to be able to receive information in a rapid and efficient manner. In addition, the proliferation of online communication tools in recent years has allowed persons to transact a growing amount of business online.

Unfortunately, the large number of available communication tools can present great difficulty to persons seeking to conduct business. For example, although email can provide a convenient, quick way to communicate offers to buy or sell goods or services to a large number of persons, existing email systems fail to provide an efficient way to communicate such offers to persons who do not have access to an email computing device at the time the communication is made. Even if email messages are queued for later viewing, such functionality does not allow an intended message recipient to view such messages until physically returning to an appropriate email computing device. Moreover, the person communicating the offer may not be present at an appropriate email computing device to view any further email messages received in connection with the proposed transaction.

Text messaging functionality offered by various wireless mobile devices can facilitate the receipt of electronic messages in text message format. Nevertheless, persons who use such mobile devices often do not know whether electronic messages will be transmitted to the mobile device, or whether the person must continue to check for email messages on a separate email computing device. Such realities can force persons to limit their electronic message communications to only a single form of communication media in order to ensure that other relevant messages are viewed in a timely fashion.

Accordingly, there exists a need for a comprehensive system which provides a streamlined approach to broadcasting electronic messages to a group of users of the system in order to facilitate online transactions. It would be desirable for such a system to allow users of the systems to receive and reply to such electronic messages while away from an email computing device.

### BRIEF SUMMARY OF THE INVENTION

The present invention, roughly described, is directed to methods and systems for broadcasting electronic offers to buy or sell to a plurality of users, thereby facilitating an electronic transaction between a sending party and the users.

In various embodiments, an electronic message comprising an offer directed to a group of users can be sent by a sending party and received by a system server. Each of the users can have associated message forwarding preferences, an associated first computing device, and an associated second computing device. The message forwarding preferences of each user can be accessed, and the online status of each of the first computing devices can be detected. The message forwarding preferences of each user can be compared with the detected online status of the first computing device associated with the user to obtain a comparison result. The electronic message can then be broadcasted to the first and/or second computing device of each user based on the comparison result obtained for each user.

In certain embodiments, the electronic message can be an email message, the first computing devices can be email computing devices, and the second computing devices can be mobile computing devices. The email message can be converted into text message format before the message is broadcasted to the mobile computing devices.

Upon receipt of a broadcasted email and/or text message, any of the users can respond to the message with a reply message directed to the sending party in email and/or text message format. The system server can forward the reply message to a first and/or second computing device of the sending party, depending on the message forwarding preferences of the sending party and the online status of the first computing device of the sending party.

These and other embodiments of the present invention are discussed in further detail below.

### BRIEF DESCRIPTION OF THE DRAWINGS

FIG. 1 is a block diagram illustrating an electronic message broadcasting system in accordance with an embodiment of the present invention.

FIG. 2 is a flowchart describing a process for informing a system server of an online status of an email computing device in accordance with an embodiment of the present invention.

FIG. 3 is a flowchart describing a process for detecting an online status of an email computing device in accordance with an embodiment of the present invention.

FIG. 4 is a flowchart describing a process for selectively converting and forwarding electronic messages to be broadcasted to a set of users in accordance with an embodiment of the present invention.

FIG. 5 is a flowchart describing a process for selectively converting and forwarding email messages to computing devices associated with an offering party in accordance with an embodiment of the present invention.

FIG. 6 is a flowchart describing a process for selectively converting and forwarding text messages to computing devices associated with an offering party in accordance with an embodiment of the present invention.

FIG. 7 is a flowchart describing a process for user interaction with an electronic message broadcasting system in accordance with an embodiment of the present invention.

### DETAILED DESCRIPTION OF THE INVENTION

An electronic message broadcasting system in accordance with the present invention can provide functionality for broadcasting buy offers and sell offers to users of the system over a plurality of communication media, such as email messages and/or text messages, thereby facilitating electronic transactions. In various embodiments, an offer can be received by the system in the form of an electronic message, such as an email message, text message, web posting, or other electronic message format. The system provides functionality for broadcasting the message to a group of users, and for selectively converting the message into a message format suitable for receipt by a computing device of each user, depending on the message forwarding preferences of each user.

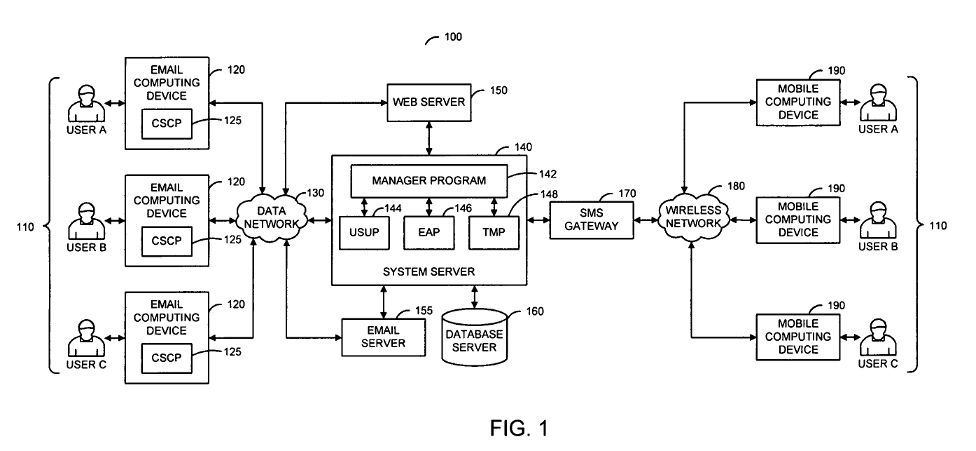

FIG. 1 is a block diagram illustrating an electronic message broadcasting system 100 in accordance with an embodiment of the present invention. Using system 100, a plurality of users 110 can interact with each other through various email computing devices 120 and mobile computing devices 190. As further described herein, email and text messages can be exchanged between users 110 through their associated email computing devices 120 and mobile computing devices 190 in accordance with message forwarding preferences of the users 110.

As illustrated in FIG. 1, each user 110 of system 100 can have an associated email computing device 120 and mobile computing device 190. Email computing devices 120 can be any computing devices known in the art capable of sending, receiving, and/or displaying email messages to a user 110. In various embodiments, computing devices 120 can be conventional personal computers, laptop computers, workstations, terminals, and/or any other type of computing device known in the art. Mobile computing devices 190 can be any appropriate mobile computing devices known in the art capable of sending and/or receiving text messages over a wireless network 180, and displaying such text messages to a user 110. It will be appreciated that mobile computing devices 190 can be mobile phones, personal digital assistants, and/or any other type of computing device known in the art. Although computing devices 120 and mobile devices 190 are described more fully herein in relation to email and text messages, respectively, it will be appreciated that support for other types of electronic messages is also contemplated by the present invention.

The system 100 can advantageously detect whether an email computing device 120 associated with a particular user 110 is online. If the associated email computing device 120 is online, then email messages intended for the user can be routed to the user's email address, and text messages intended for the user can be converted into email messages for routing to the user's email address. However, if the email computing device 120 is offline, then text messages intended for the user can be routed to the user's mobile computing device 190, and email messages intended for the user can be converted into text messages which are forwarded to the user's mobile computing device 190. As a result, users of system 100 can view email messages as text messages while away from an email computing device 120, and can further view text messages as email messages while at the email computing device 120.

Each of email computing devices 120 can communicate with a data network 130 which facilitates communication between various components of system 100. For example, email messages sent from email computing devices 120 over network 130 can be received by an email server 155 for further processing by system 100. Network 130 can be any of the various networks known in the art to facilitate data transmission, including but not limited to the Internet, a wide area network (WAN), a virtual private network (VPN), a wireless network, and/or others known in the art.

System 100 can optionally provide a web site through a web server 150 permitting users 110 to login and/or register with the system 100 by providing registration information through the web site. Users 110 who are registered members of the system 100 can be permitted to enter their message forwarding preferences through the web site, as further described herein.

A system server 140 provides the message broadcasting, routing, and conversion functionality of system 100. As illustrated, system server 140 is in communication with a web server 150, email server 155, database server 160, SMS gateway 170, and network 130. Various software applications 142, 144, 146, and 148 can be provided on system server 140 for instructing the server 140 to perform specific functionality described more fully herein. Message forwarding preferences of users 110 can be stored in database server 160 which is in communication with system server 140. Such message forwarding preferences can include preferences selected by users 110 pertaining to the manner and conditions under which electronic email and/or text messages will be converted and/or forwarded by system server 140 to the email computing devices 120 and/or mobile computing devices 190 of users 110. For example, such conditions can include but need not be limited to: the message sender, time, date, on/off/idle status of a user's 110 email computing device 120, and/or other conditions. In one embodiment, the message forwarding preferences can specify that all email and/or text messages received from a particular set of users 110 of system 100 (or other persons) should be forwarded to a receiving party's mobile computing device 190 whenever the receiving party's email computing device 190 is offline.

Email server 155 is in communication with network 130 and system server 140 for receiving email messages sent by one or more email computing devices 120 and passing such email messages to system server 140. Database server 160 is in communication with system server 140 for storing message forwarding preferences of users 110.

SMS gateway 170 is in communication with system server 140 and a wireless network 180, thereby facilitating communication between system server 140 and the wireless network 180. Wireless network 180 can be any appropriate network that facilitates wireless communication to and from mobile computing devices 190, such as GSM/PCS digital cellular network or others known in the art.

Each of mobile computing devices 190 can communicate with wireless network 180 for exchanging text messages with other components of the system 100. For example, text messages sent from mobile computing devices 190 over network 180 can be received by SMS gateway 170 for further processing by system 100.

A client status checking program (“CSCP”) 125 is provided on each email computing device 120. As further described herein, CSCP 125 operates to send information to system server 140 while the email computing device 120 is online. When a user 110 turns on an email computing device 120, CSCP 125 can be executed automatically and loaded into the memory of the email computing device 120. In various embodiments, CSCP 125 can generate data packets which contain a user's settings, name, and login status. Such packets are sent through network 130 to system server 140.

Turning now to the software applications running on system server 140, it will be appreciated by those skilled in the art that discreet software applications 142, 144, 146, and 148 are illustrated as running on system server 140. However, any appropriate arrangement of software components can be employed to provide the functionality of system server 140 described herein. It will also be appreciated that although database server 160 is illustrated as separate from system server 140, the storage of user message forwarding preferences can be provided in accordance with any storage technology known in the art, including but not limited to one or more separate databases.

A user status update program (“USUP”) 144 is provided on system server 140 for receiving and analyzing data packets transmitted by the various CSCP 125 programs running on email computing devices 120. USUP 144 waits to receive a data packet from CSCP 125 within a predetermined time interval. If no data packet is received within the time interval, then the USUP 144 determines that the email computing device 120 is offline. If a data packet is received, then USUP 144 determines that the email computing device 120 is online. The USUP 144 then decodes the data packet and updates the online status associated with the email computing device 120 running the CSCP 125. USUP 144 can also be provided with functionality for updating user settings extracted from such data packets and updating those settings in database server 160. In various embodiments, USUP can be implemented as a software program written in ASP, VC++, and VB programming languages.

A manager program 142 is also provided on system server 140 for managing the selective forwarding of electronic messages in accordance with the present invention. Manager program 142 receives data from USUP 144 as to which email computing devices 120 are online. In response to a detected online status, manager program 142 can selectively convert electronic messages received in email format into text message format, and vice versa. The converted messages can then be forwarded to an email computing device 120 and/or mobile computing device 190 as desired.

An email analyze program (“EAP”) 146 is further provided on system server 140 for analyzing email messages received from email server 155. In various embodiments, EAP 146 can analyze the header of such email messages and identify the sending and receiving parties. If both parties are authorized users of system 100, or have software sufficient to interact with system server 140, then such email messages will be passed to manager program 142.

A text messaging program (“TMP”) 148 is also provided on system server 140 for sending and receiving text messages between system server 140 and SMS gateway 170.

CSCP 125 can be implemented as a client side software program written in VC++ and VB programming languages. In various embodiments, CSCP 125 is preinstalled into each of computing devices 120 before such devices can interact with system 100.

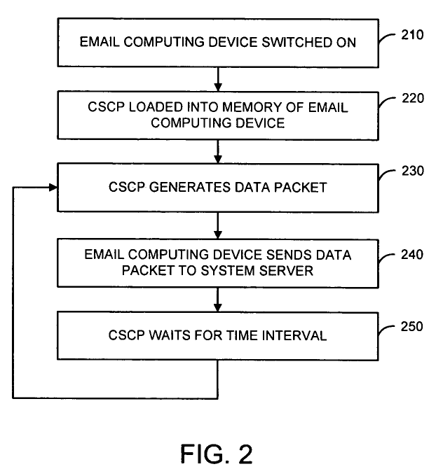

FIG. 2 is a flowchart describing a process for informing system server 140 of an online status of an email computing device 120 in accordance with an embodiment of the present invention.

In initial step 210, an email computing device 120 is switched on and begins its boot up cycle. Typically, step 210 will be performed in response to a user's 110 decision to switch on the email computing device 120. During the boot up cycle, CSCP 125 is loaded into the memory of device 120 and begins running (step 220).

While the CSCP 125 is running, it periodically generates a data packet (step 230) to be sent by the email computing device 120. The data packet sent in step 230 can comprise any desired collection of data desirable to be sent to system server 140. For example, the data packet could identify the user's 110 name, message forwarding preferences, login status, and/or other information.

In step 240, the data packet is sent by the email computing device to system server 140 over network 130. After the data packet is sent, the CSCP 125 waits for a preselected time interval (step 250) before returning to step 230 and generating the next data packet. In various embodiments, the time interval identified in step 250 can be set by the user 110 as part of the user's 110 message forwarding preferences.

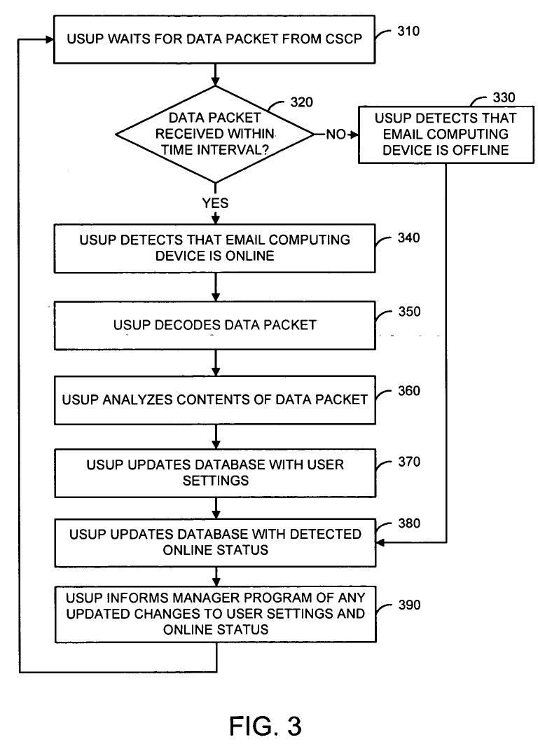

It will be appreciated that steps 230, 240, and 250 collectively identify an iterative process during which data packets are periodically sent from the email computing device 120 to system server 140. However, the iterative process can be interrupted if CSCP 125 stops functioning and/or if the email computing device 120 is switched off. CSCP 125 can also be implemented to perform the iterative process only while a user 110 is logged in to the email computing device 120 and/or is logged in to a website provided by web server 150. Similarly, if communications between email computing device 120 and network 130 are interrupted, then data packets sent by the email computing device 120 will not be received by system server 140. As further described herein in relation to FIG. 3, the interruption of this iterative process can facilitate the detection by system server 140 of whether the email computing device 120 is online.

FIG. 3 is a flowchart describing a process for detecting an online status of an email computing device 120 in accordance with an embodiment of the present invention. The process of FIG. 3 can be performed by the USUP 144 software running on system server 140.

At step 310, USUP 144 waits to receive a data packet from the CSCP 125 program running on an email computing device 120. If no data packet is received within a predetermined time interval (step 320), then USUP 144 detects that the email computing device 120 is offline (step 330), and the process of FIG. 3 proceeds to step 380.

If, however, a data packet is received by USUP 144 (step 320), then USUP 144 detects that the email computing device 120 is online (step 340). USUP 144 then decodes the data packet (step 350) and analyzes the contents (step 360). USUP 144 updates database server 160 with any user settings contained in the data packet, such as message forwarding preferences of the user (step 370).

At step 380, USUP 144 updates the database server 160 with the online status detected in step 330 (if no data packet was received) or step 340 (if a data packet was received). USUP 144 informs the manager program 142 of any changes to the user's 110 settings and online status of the user's 110 email computing device 120. The process then returns to step 310 where USUP 144 waits for the next data packet to arrive.

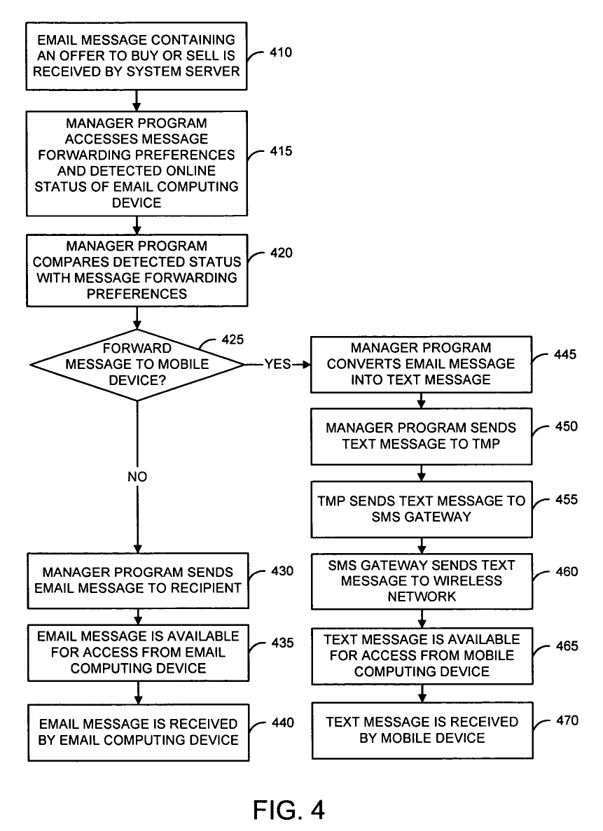

It will be appreciated that process of FIG. 3 provides system server 140 with an online status associated with a given email computing device 120 (i.e. whether the email computing device 120 is online or offline). As explained in relation to FIGS. 4, 5, and 6 below, this online status can be used by software running on system server 140 to take appropriate action in converting and/or forwarding electronic messages to appropriate computing devices for users 110 of system 100.

FIG. 4 is a flowchart describing a process for selectively converting and forwarding electronic messages to be broadcasted to a set of users in accordance with an embodiment of the present invention.

At step 410, system server 140 receives an email message from a sending party, the message containing a buy offer or a sell offer. In various embodiments the message can be directed to any combination of the users 110 of system 100, such as all of the users or some of the users (i.e. a group, set, and/or subset of the users). In various embodiments, the email message can be transmitted from an email computing device 120 of a sending party who is one of the users 110 of system 100. The message can be received by email server 155 and passed to system server 140. In another embodiment, the email message can be generated by a web site provided by web server 150 in response to a sending party's interaction with the web site, such as in response to a posting to the web site made by the sending party. In yet another embodiment, the email message can be a “Buy i-Message” or a “Sell i-Message” generated in response to the sending party's utilization of an “i-Message” tool provided through the web site www.ibizlink.com.

Upon receipt of the email message, the system server 140 can proceed to broadcast the message to each user 110 of system 100 to whom the message is directed, in accordance with the remaining steps of FIG. 4. It will be appreciated that the process identified by steps 415 through 470 can be repeated for each of the users 110 to whom the electronic message is to be broadcasted.

At step 415, the manager program 142 of system server 140 accesses the message forwarding preferences of a user 110 to whom the electronic message is directed, and further accesses the detected online status of the email computing device 120 associated with the user (step 415). In one embodiment, the information accessed in step 415 is obtained from database server 160. In another embodiment, such information is obtained from USUP 144.

At step 420, manager program 142 compares the detected online status (accessed in step 415) with the message forwarding preferences (also accessed in step 415) to obtain a comparison result. In response to the comparison result, manager program 142 determines whether the email message should be forwarded to a mobile device 190 associated with the user 110 (step 425).

For example, if the user's message forwarding preferences indicate that email messages should be forwarded to the user's mobile device 190 when the user's email computing device 120 is offline, then the process of FIG. 4 will proceed to step 445 if the online status (detected in FIG. 3) indicates that the email computing device 120 is offline. Otherwise, the process proceeds to step 430 where the email message is sent to the email address of the user. The email message is made available for access from the email computing device 120 of the user (step 435) and can be received by the email computing device 120 when the user checks the email computing device 120 for email messages (step 440).

At step 445, manager program 142 converts the email message into a text message suitable for transmission to a mobile computing device 190. The manager program 142 then sends the newly converted text message to TMP 148 (step 450) which proceeds to send the text message to SMS gateway 170 (step 455). Upon receiving the text message, the SMS gateway sends the text message to wireless network 180 (step 460) where it is available for access from the user's mobile device 190 (step 465). The converted text message will then be received by the mobile device 190 (step 470) when the user checks the mobile device 190 for text messages.

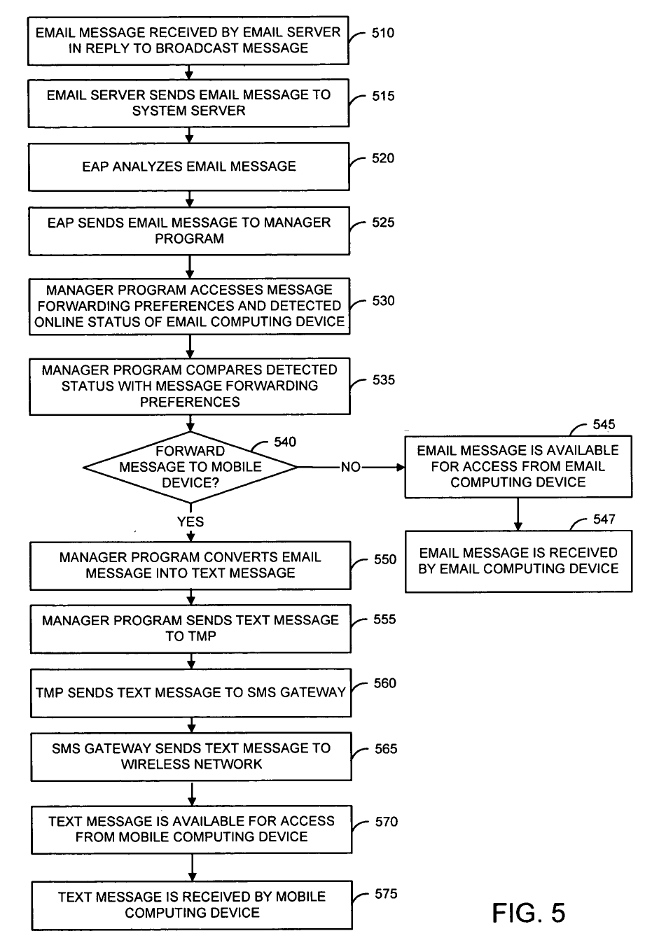

In addition to the particular embodiment set forth in the discussion of FIG. 5 above, it will be appreciated that system 100 can also be implemented to always make email messages available for access from the user's associated email computing device 120 and/or mobile computing device 190, regardless of whether the messages are also forwarded to another computing device associated with the user.

It will be appreciated that by repeating steps 415 through 470 for each user 110 of the system 100, all users will receive the offer contained in the original email message received in step 410. Moreover, the offer will be received in an appropriate message format (email message format or text message format) in accordance with each user's particular message forwarding preferences.

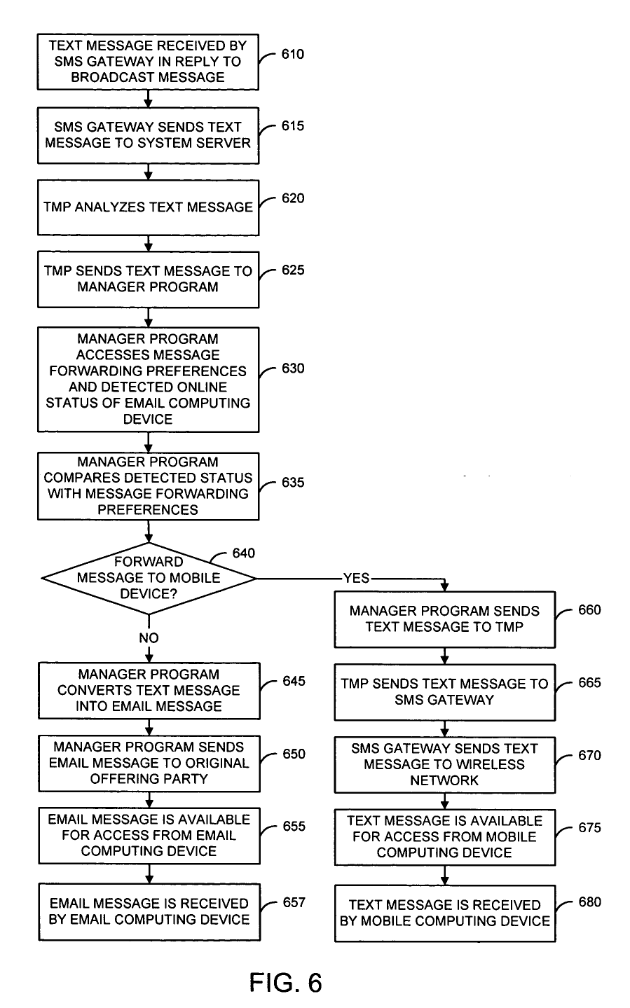

An electronic message broadcasted in accordance with the process of FIG. 4 may be received as an email message accessible from an email computing device and/or a text message accessible from a mobile computing device. Upon receipt of the email message or text message, the users 110 may choose to respond with an email message or text message reply directed to the original sending party (i.e. the person sending the message comprising an offer received in step 410). As further explained below with regard to FIGS. 5 and 6, any such reply email message or reply text message can be forwarded to the original sending party in accordance with the message forwarding preferences of the original sending party.

FIG. 5 is a flowchart describing a process for selectively converting and forwarding email messages to computing devices associated with an offering party in accordance with an embodiment of the present invention.

At step 510, email server 155 receives an email message over network 130 in reply to an email message containing an offer that was previously broadcasted in accordance with the process of FIG. 4. The email server 155 then sends the message to system server 140 (step 515). At step 520, EAP 146 running on system server 140 analyzes the email message to determine the person sending the reply and the intended receiving party indicated by the reply email message. In one embodiment, EAP 146 reviews the reply email message to determine whether the person sending the reply and/or the receiving party is a registered user 110 of system 100. In another embodiment, EAP 146 reviews the header portion of the reply email message to determine whether it contains an email address of a user 110 of system 100. EAP 146 then sends the email message to manager program 142 (step 525).

It will be appreciated that, with regard to FIG. 5, the intended receiving party designated in the reply email message will be the sending party previously described in relation to step 410 of FIG. 4 (“original offering party”). Upon receiving the reply email message, manager program 142 accesses the message forwarding preferences of the original offering party, and further accesses the detected online status of the email computing device 120 associated with the original offering party (step 530). In one embodiment, the information accessed in step 530 is obtained from database server 160. In another embodiment, such information is obtained from USUP 144.

At step 535, manager program 142 compares the detected online status (accessed in step 530) with the message forwarding preferences (also accessed in step 530) to obtain a comparison result. In response to the comparison result, manager program 142 determines whether the email message should be forwarded to a mobile device 190 associated with the original offering party (step 540).

For example, if the original offering party's message forwarding preferences indicate that email messages from the person sending the reply should be forwarded to the original offering party's mobile device 190 when the original offering party's email computing device 120 is offline, then the process of FIG. 5 will proceed to step 550 if the online status (detected in FIG. 3) indicates that the email computing device 120 is offline. Otherwise, the process proceeds to step 545 where the email message is made available for access from the email computing device 120 and can be received by the email computing device 120 when the original offering party checks the email computing device 120 for email messages (step 547).

At step 550, manager program 142 converts the email message into a text message suitable for transmission to a mobile computing device 190. The manager program 142 then sends the newly converted text message to TMP 148 (step 555) which proceeds to send the text message to SMS gateway 170 (step 560). Upon receiving the text message, the SMS gateway sends the text message to wireless network 180 (step 565) where it is available for access from the original offering party's mobile device 190 (step 570). The converted text message will then be received by the mobile device 190 (step 575) when the original offering party checks the mobile device 190 for text messages.

In addition to the particular embodiment set forth in the discussion of FIG. 5 above, it will be appreciated that system 100 can also be implemented to always make email messages available for access from the original offering party's associated email computing device 120 and/or mobile computing device 190, regardless of whether the messages are also forwarded to another computing device associated with the original offering party.

FIG. 6 is a flowchart describing a process for selectively converting and forwarding text messages to computing devices associated with an offering party in accordance with an embodiment of the present invention.

At step 610, SMS gateway 170 receives a text message over wireless network 180 in reply to a text message containing an offer that was previously broadcasted to a user 110 in accordance with the process of FIG. 4. SMS gateway 170 then sends the message to system server 140 (step 615). At step 620, TMP 148 analyzes the text message to determine the person sending the reply and intended receiving party indicated by the reply text message. In one embodiment, TMP 148 reviews the reply text message to determine whether the person sending the reply and/or the receiving party is a registered user 110 of system 100. TMP 148 then sends the text message to manager program 142 (step 625).

It will also be appreciated that, with regard to FIG. 6, the intended receiving party designated in the reply text message will be the original offering party. Upon receiving the reply text message, manager program 142 accesses the message forwarding preferences of the original offering party, and further accesses the detected online status of the email computing device 120 associated with the original offering party (step 630). In one embodiment, the information accessed in step 630 is obtained from database server 160. In another embodiment, such information is obtained from USUP 144.

At step 635, manager program 142 compares the detected online status (accessed in step 630) with the message forwarding preferences (also accessed in step 630) to obtain a comparison result. In response to the comparison result, manager program 142 can determine whether the text message should be forwarded to a mobile device 190 or email computing device 120 associated with the original offering party (step 640).

If the message forwarding preferences indicate that text messages from the person sending the reply should be forwarded to the original offering party's mobile device 190 when the original offering party's email computing device 120 is offline, then the process of FIG. 6 will proceed to step 660 if the detected online status indicates that the email computing device 120 is offline.

If it is determined that the text message should not be forwarded to the original offering party's mobile computing device 190 (step 640), then manager program 142 generates an email message by converting the text message into an email message format (step 645). Manager program 142 then sends the converted email message to the email address of the original ofering party (step 650). Thereafter, the converted email message can be available for access from the email computing device 120 (step 655) and can be received at the email computing device 120 (step 657) when the original offering party checks the email computing device 120 for email messages.

If it is determined that the text message should be forwarded to the original offering party's mobile computing device 190 (step 640), then manager program 142 sends the text message to TSP 148 (step 660) which sends the text message to SMS gateway 170 (step 665). Upon receiving the text message, the SMS gateway sends the text message to wireless network 180 (step 670) where it is available for access from the original offering party's mobile device 190 (step 675). The converted text message will then be received by the mobile device 190 (step 680) when the original offering party checks the mobile device 190 for text messages.

In addition to the particular embodiment set forth in the discussion of FIG. 6 above, it will be appreciated that system 100 can also be implemented to always make text messages available for access from the original offering party's associated email computing device 120 and/or mobile computing device 190, regardless of whether the messages are also forwarded to another computing device associated with the original offering party.

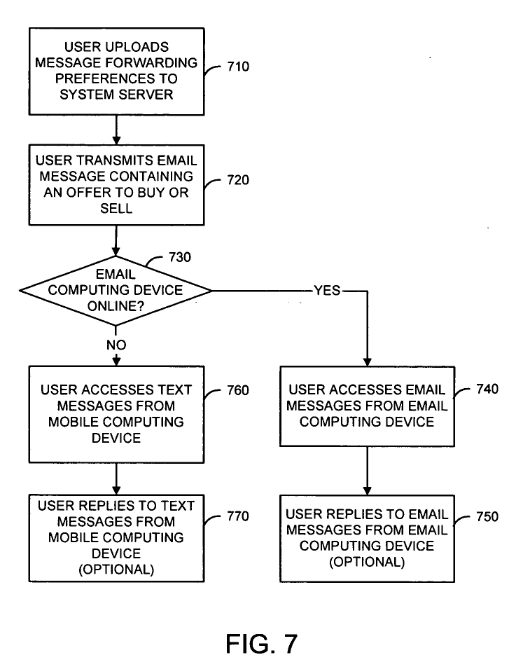

FIG. 7 is a flowchart describing a process for user interaction with an electronic message broadcasting system 100 in accordance with an embodiment of the present invention. It will be appreciated that the steps of FIG. 7 illustrate the perspective of a user of system 100 having an associated email computing device 120 and mobile computing device 190. For example, the user may be a buyer or seller (i.e. the original offering party) desiring to broadcast an electronic offer to buy or sell to the other users 110 of system 100.

At initial step 710, the user uploads the user's desired message forwarding preferences to system server 140. It will be appreciated that step 710 can be performed by the user inputting the message forwarding preferences into a web page provided by web server 150, or through any of the various ways known in the art for providing data to a server. In response, system server 140 stores the preferences on database server 160. Thereafter, system 100 will forward and/or convert email messages and text messages directed toward the user in accordance with the stored message forwarding preferences.

At step 720, the user transmits an email message containing an offer to buy or sell to the system 100. As previously described herein, the email message can be received by system server 140 and broadcasted to various users 110 of system 100 in accordance with the process of FIG. 4. As also previously described herein, users 110 of system 100 receiving the offer may choose to reply to the broadcasted offer in the form of a reply email message or a reply text message (see steps 510 and 610 of FIGS. 5 and 6, respectively). For example, such reply messages may comprise an acceptance of the offer, a counteroffer, a request for further information, and/or any other message sent in reply. Such reply messages can be received by the user as email messages and/or text messages, depending on the message forwarding preferences of the user in accordance with the processes of FIGS. 5 and 6.

If the user's email computing device 120 is online (step 730), then the user can access email messages (including text messages converted into email messages) from the user's email computing device 120 (step 740). The user can optionally reply to the email messages (step 750) from the email computing device 120. In contrast, if the user's email computing device 120 is offline (step 730), then the user can access text messages (including email messages converted into text messages) from the user's mobile computing device 190 (step 760). The user can optionally reply to the text messages (step 770) from the mobile computing device 190.

It will be appreciated that if the user chooses to send an email message (step 750) or text message (step 770) to another user of system 100, then such messages can be processed by system 100 in accordance with the message forwarding preferences of the second user. Thus, by setting the message forwarding preferences as desired, the user can send offers to be broadcasted to various other users 110 of the system 100, receive replies to the offers regardless of whether the user is physically present at an email computing device 120, and send messages in response to such replies. Such response messages can be received by a replying party regardless of whether the replying party is physically present at an email computing device 120.

It will be appreciated that the scope of the present invention is not limited by the particular embodiments set forth herein. Other appropriate variations, whether explicitly provided for or implied, are contemplated by the present disclosure. The ordering of various steps described herein can be changed where appropriate to achieve the functionality provided by the present invention. Similarly, individual steps can be combined and/or dissected into fewer or greater numbers of steps where appropriate to provide the functionality described herein.

What is claimed is:

1. A method for facilitating an electronic transaction between a sending party and a group of users over a plurality of communication media, the sending party and each of the users having message forwarding preferences, a first associated computing device, and a second associated computing device, the method comprising:
receiving a first electronic message from the sending party, the first electronic message comprising an offer directed to the users;
accessing the message forwarding preferences for at least one of the users;
detecting an online status of the first computing device of the at least one of the users;
comparing the detected online status with the message forwarding preferences of the at least one of the users to obtain a first comparison result;
broadcasting the first electronic message to the at least one of the users through communication media determined by the first comparison result, the first electronic message being received by at least one the computing devices of the at least one of the users regardless of whether the first associated computing device of the at least one of the users is online; and
performing the accessing, detecting, comparing, and broadcasting steps for each of the users.

2. The method of claim 1, the broadcasting step comprising:
sending the first electronic message to the second computing device of the at least one of the users if the detected online status of the first computing device of the at least one of the users indicates the first computing device of the at least one of the users is offline.

3. The method of claim 2, the first computing device of each of the users is an email computing device, the second computing device of each of the users is a mobile computing device.

4. The method of claim 3, the method further comprising:
converting the first electronic message from an email message into a text message prior to the broadcasting step.

5. The method of claim 3, at least one of the mobile computing devices is a mobile phone.

6. The method of claim 3, at least one of the email computing devices is a personal computer.

7. The method of claim 1, the detecting step comprising:
receiving a data packet from the first computing device of the at least one of the users; and
storing the online status in response to receiving the data packet.

8. The method of claim 1, the method is performed by software running on a system server.

9. The method of claim 1, the method further comprising:
receiving a second electronic message from the at least one of the users, the second electronic message comprising a reply to the first electronic message.

10. The method of claim 9, the method further comprising:
accessing the message forwarding preferences for the sending party;
detecting an online status of the first computing device of the sending party;
comparing the detected online status of the first computing device of the sending party with the message forwarding preferences of the sending party to obtain a second comparison result; and
forwarding the second electronic message to the sending party through communication media determined by the second comparison result, the second electronic message being received by at least one the computing devices of the sending party regardless of whether the first associated computing device of the sending party is online.

11. The method of claim 10, the forwarding step comprising:
sending the second electronic message to the second computing device of the sending party if the detected online status of the first computing device of the sending party indicates the first computing device of the sending party is offline.

12. The method of claim 11, the first computing device of the sending party is an email computing device, the second computing device of the sending party is a mobile computing device.

13. The method of claim 12, the method further comprising:
converting the second electronic message from an email message into a text message prior to the forwarding step.

14. A method for initiating an electronic transaction between a sending party and a group of users over a plurality of communication media, the sending party having a first associated computing device and a second associated computing device, the method comprising:
setting message forwarding preferences of the sending party in a database;
sending a first electronic message over a first electronic network, the first electronic message comprising an offer directed to the users, the first network employing a first communication media; and
receiving a second electronic message from at least one of the users, the second electronic message comprising a reply to the first electronic message, the second electronic message being received by the second computing device over a second electronic network if a detected online status of the first computing device indicates that the first computing device is offline, the second network employing a second communication media.

15. The method of claim 14, the first computing device is an email computing device, the second computing device is a mobile computing device.

16. The method of claim 15, the method further comprising:
sending a third electronic message to the at least one of the users, the third electronic message comprising a reply to the second electronic message.

17. The method of claim 16, the third electronic message being sent by the second computing device over the second network.

18. The method of claim 17, the first network is the Internet, the second network is a wireless network.

19. A system for facilitating an electronic transaction between a sending party and a group of users over a plurality of communication media, the sending party and each of the users having message forwarding preferences, a first associated computing device, and a second associated computing device, the system comprising:
a system server;
a database for storing the message forwarding preferences; and
application software running on the system server operable to perform the steps of:
receiving a first electronic message from the sending party, the first electronic message comprising an offer directed to the users,
accessing the message forwarding preferences for at least one of the users from the database,
detecting an online status of the first computing device of the at least one of the users,
comparing the detected online status with the message forwarding preferences of the at least one of the users to obtain a first comparison result,
broadcasting the first electronic message to the at least one of the users through communication media determined by the first comparison result, the first electronic message being received by at least one the computing devices of the at least one of the users regardless of whether the first associated computing device of the at least one of the users is online, and
performing the accessing, detecting, comparing, and broadcasting steps for each of the users.

20. The system of claim 19, the broadcasting step comprising:
sending the first electronic message to the second computing device of the at least one of the users if the detected online status of the first computing device of the at least one of the users indicates the first computing device of the at least one of the users is offline.

21. The system of claim 20, the first computing device of each of the users is an email computing device, the second computing device of each of the users is a mobile computing device.

22. The system of claim 21, the software being further operable to perform the step of:
converting the first electronic message from an email message into a text message prior to the broadcasting step.

23. The system of claim 19, the detecting step comprising:
receiving a data packet from the first computing device of the at least one of the users; and
storing the online status in response to receiving the data packet.

24. The system of claim 19, the software being further operable to perform the step of:
receiving a second electronic message from the at least one of the users, the second electronic message comprising a reply to the first electronic message.

25. The system of claim 24, the software being further operable to perform the steps of:
accessing the message forwarding preferences for the sending party;
detecting an online status of the first computing device of the sending party;
comparing the detected online status of the first computing device of the sending party with the message forwarding preferences of the sending party to obtain a second comparison result; and
forwarding the second electronic message to the sending party through communication media determined by the second comparison result, the second electronic message being received by at least one the computing devices of the sending party regardless of whether the first associated computing device of the sending party is online.

26. The system of claim 25, the forwarding step comprising:
sending the second electronic message to the second computing device of the sending party if the detected online status of the first computing device of the sending party indicates the first computing device of the sending party is offline.

27. The system of claim 26, the first computing device of the sending party is an email computing device, the second computing device of the sending party is a mobile computing device.

28. The system of claim 27, the software being further operable to perform the step of:
converting the second electronic message from an email message into a text message prior to the forwarding step.
